(19) United States
(12) Patent Application Publication
(10) Pub. No.: US 2024/0040136 A1
(43) Pub. Date: Feb. 1, 2024

(54) METHOD TO OPTIMIZE THE QUALITY OF VIDEO DELIVERED OVER A NETWORK

(71) Applicant: ARRIS Enterprises LLC, Suwanee, GA (US)

(72) Inventor: Stephen J. Kraiman, Doylestown, PA (US)

(73) Assignee: ARRIS Enterprises LLC, Suwanee, GA (US)

(21) Appl. No.: 18/379,595

(22) Filed: Oct. 12, 2023

Related U.S. Application Data
(63) Continuation of application No. 14/584,044, filed on Dec. 29, 2014.

(51) Int. Cl. H04N 19/40; H04N 19/124; H04N 19/132; H04N 19/164

(52) U.S. Cl. CPC H04N 19/40; H04N 19/124; H04N 19/132; H04N 19/164

(57) ABSTRACT

A system and method for transcoding data. The system includes an adaptive transcoder that transcodes data to produce transcoded data having a first data rate, and transmits the transcoded data to a client device. The adaptive transcoder receives a quality signal. The adaptive transcoder transcodes the data at a second data rate in response to the adaptive transcoder determining that the quality signal indicates that the first data rate is deficient based on at least one of processing capabilities of the client device and network connection capabilities between the adaptive transcoder and the client device.

### TECHNICAL FIELD

The examples described herein, in general, relate to controlling a bit rate of a video signal being transmitted to a client device.

### BACKGROUND

In recent years, delivering information (e.g. video content) over networks, such as an IP network has become increasingly popular. In these conventional systems, an IP device such as a mobile phone or PC may receive video content from a server over a standard Internet Protocol Suite (TCP/IP) connection utilizing hypertext transfer protocol (HTTP).

Some conventional video content delivery systems transcode video content at a single bit rate. However, transcoding the video content at the single bit rate causes problems. Specifically, in one example, when the bit rate is too high for the client device (i.e. the client device cannot process the data fast enough), the buffers in the client device could overflow and transmitted video data could be lost. In another example, when the bit rate is too low for the client device (i.e. the client device may process more data than is being delivered), the video playback will not be at the highest quality capable of being produced by the client device, and may even pause when insufficient data has been received.

Other conventional video content delivery systems attempt to solve this problem by transcoding the video content at multiple bit rates. However, transcoding the video content at multiple bit rates significantly increases the processing and storage requirements of video content at the server.

### SUMMARY

The following description and the accompanying drawings disclose examples of a system and method for transcoding data. The transcoding may include recoding video data from one bit rate to another by controlling video quantization, video resolution and/or video encoding format.

In one example, the system includes an adaptive transcoder that receives data (e.g. video data), and encodes the received data to produce transcoded data having a first data rate. This transcoded data is then transmitted to a client device. The adaptive transcoder then receives an indicator signal from the client device, and then transcodes the data to produce output data having a second data rate (e.g. the data rate is increased/decreased). This transcoding is performed in response to the indicator signal indicating that the first data rate is deficient based on at least one of processing capabilities of the client device and network connection capabilities between the adaptive transcoder and the client device. In this transcoding example, the video resolution and encoding format of the data may in addition/alternatively be changed or may be maintained.

Additional advantages and novel features will be set forth in part in the description which follows, and in part will become apparent to those skilled in the art upon examination of the following and the accompanying drawings or may be learned by production or operation of the examples. The advantages of the present teachings may be realized and attained by practice or use of various aspects of the methodologies, instrumentalities and combinations set forth in the detailed examples discussed below.

### BRIEF DESCRIPTION OF THE DRAWINGS

The figures depict one or more implementations in accordance with the present teachings by way of example only, not by way of limitation. In the figures, like reference numbers refer to the same or similar elements.

FIG. 1A shows a block diagram of a video content delivery system that transcodes the content into a single bit rate.

FIG. 1B shows a block diagram of a video content delivery system that transcodes the content into multiple bit rates.

FIG. 2 shows a block diagram of a video content delivery system that includes an adaptive transcoder.

FIG. 3 is a block diagram, which shows details of the media gateway in FIG. 2.

FIG. 4 shows a block diagram of an adaptive transcoder connected between the network and the client device.

FIG. 5 shows a block diagram showing the details of the adaptive transcoder in FIG. 4.

FIG. 6 shows a flow chart of how the adaptive transcoder would monitor the client device processing performance and adjust the bit rate accordingly.

FIG. 7 shows a block diagram of a computer that may be configured as a host or server, for example, to function as the various devices in FIGS. 2, 3 and 4.

FIG. 8 is a block diagram of a personal computer or other work station or terminal device, for example, to function as the client device shown in FIGS. 2, 3 and 4.

### DETAILED DESCRIPTION OF EXAMPLES

In the following detailed description, numerous specific details are set forth by way of examples in order to provide a thorough understanding of the relevant teachings. However, it should be apparent that the present teachings may be practiced without such details. In other instances, well-known methods, procedures, components, and/or circuitry have been described at a relatively high level, without detailed comment in order to avoid unnecessarily obscuring aspects of the present teachings.

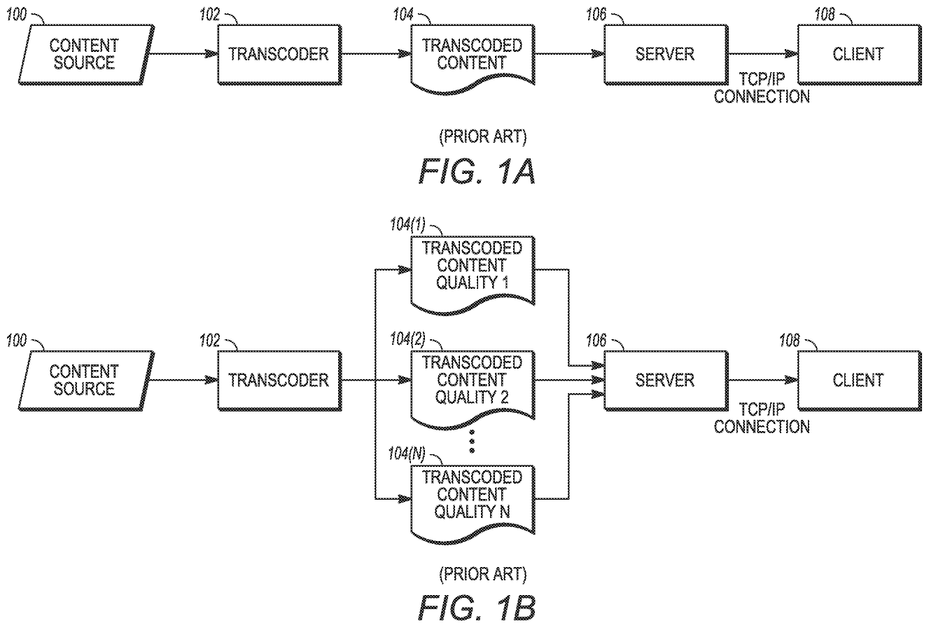

In recent years, transmission of video content over an IP network has become increasingly popular. Two examples of systems for transmitting video content over an IP network are shown in FIGS. 1A and 1B. Specifically, FIG. 1A shows a content source 100 (i.e., the source of the video) which inputs the video content to transcoder 102. Transcoder 102 may be able to transcode the video content in any number of formats (e.g., MPEG-2, MPEG-4, etc.), any number of bit rates (e.g. low, medium, high, etc.), and any number of resolutions (e.g. standard definition, high definition, etc.). This transcoded content 104 is then transmitted to server 106 which is then delivered to client device 108 at a fixed bit rate, over a TCP/IP connection. However, supplying the content at one bit rate may lead to the video skipping, pausing or low quality video viewing experienced by the user of the client device 108 (i.e. the bit rate is not optimized to the client device processing abilities or the capacity of the network).

Alternatively, in FIG. 1B, transcoder 104 may be replaced by multiple transcoders 104(1)-104(N). The video content supplied by content source 100 may be transcoded in N different bit rates. This allows the client device 108 to request an appropriate bit rate based on the client's processing abilities and the network TCP/IP network connection speed between server 106 and client device 108. This technique, however, requires relatively large amounts of processing in order to transcode the video in the various bit rates, and also relatively large memories to store the various transcoded video files.

A need therefore exists to provide the client device with video content having an optimal bit rate, while not requiring large processing and storage requirements by the transcoder and server.

One solution to such a problem is to have an adaptive transcoder that is able to automatically (i.e. dynamically) change the bit rate based on real-time requirements (e.g. TCP window size) of the client device. For example, the adaptive transcoder may dynamically transcode the content while monitoring the TCP/IP connection to determine how quickly the client device is consuming the data. If the server is determined to be producing data at a rate too fast for the client device capabilities, then the adaptive transcoder decreases the bit rate of the data being sent to the client device. If the server is determined to be producing data at a rate below the client device capabilities, then the adaptive transcoder increases the bit rate of the data being sent to the client device. The adaptive transcoder is dynamically adapting the bit rate to the real-time processing and network connection requirements of client device 208.

The transcoder may adapt the bit rate of the data sent to the client device in a number of ways. First, the quantization of the video signal may be controlled (see below for more detail). Second, the resolution of the video signal may be controlled (i.e. switching from low, medium and high resolution). Third, the frame rate of the video may be controlled. These are just three examples of how the transcoder can adapt the bit rate of the video data sent to the client device. Other equivalent methods that affect bit rate may also be used.

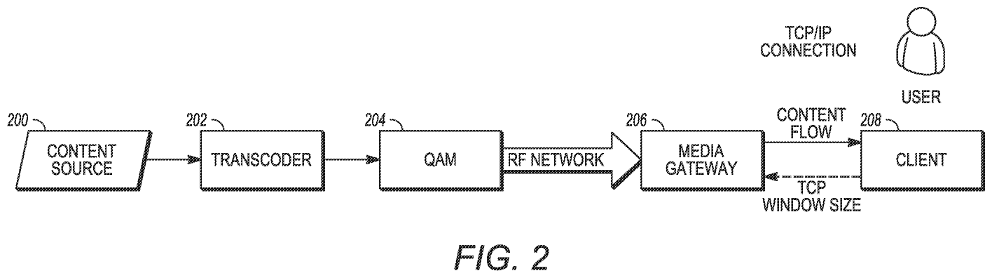

One example of an adaptive transcoder system is shown in FIG. 2. In FIG. 2, content source 200 may be a satellite receiver which typically transports MPEG-2 or MPEG-4 video over an IP multicast. In this example, transcoder 202 may subscribe to the IP multicast and receive the MPEG video. The transcoder may then re-encode the content into a predetermined format, resolution and/or output data rate. Optionally, the transcoder may also include a groomer (not shown) to accept multiple video streams and merge them into a Multi-Program Transport Stream (MPTS). In general, the transcoder may use a multicast IP transport to make the MPTS available to other devices such as the quadrature amplitude modulation (QAM) device 204 which subscribes to the IP multicast. The QAM may then modulate the bits and transmit the video via radio frequency (RF) communications. The media gateway then tunes to the RF QAM signal and accesses the desired Single Program Transport Stream (SPTS) within the MPTS.

As shown in FIG. 2, the video content may flow from media gateway 206 (e.g. gateway installed in user's home) to client device 208 (e.g. cable box in user's home) over a TCP/IP connection. In order to monitor the performance of the client device and how the client device is consuming the video content, the media gateway 206 may monitor the TCP window size being requested by client device 208 (e.g. cable box, personal computer, mobile device, etc.). The requests regarding TCP window size may be utilized to adapt the transcoded bit rate depending on the client's needs (e.g. processing capabilities, network connection speed, etc.).

In general, TCP window size is indicated as 16 bits in the TCP header of a TCP segment (e.g. TCP segment transmitted from the client device to the media gateway). This header information allows the client device (e.g. the receiving device) to indicate how much data it wants to receive before sending an acknowledgment. Once the window size is set, the sender (e.g. media gateway) transmits the requested amount of data, and then stops sending to await acknowledgement. Alternately, the sender may continue to send data until the expected arrival time of the acknowledgement.

The client device may select a TCP window size based on any one or more of a number of criteria, such as its own processing capacity, its input buffer status and network performance parameters such as error rate, bit rate or latency. Of note for purposes of the present discussion, the sender will also utilize the requested TCP window size as a performance indicator for dynamically adjusting the transcoder operation so as to dynamically adjust the bit rate of the transcoded data stream sent to the client device.

In the system of FIG. 2, for example, assuming the client device has large amounts of processing power, the TCP window size may initially be set to the maximum value (e.g. 65 KB of data per transmission). The media gateway may then transmit 65 KB of high quality video data (e.g. data that has high quantization resolution) and wait for an acknowledgment from the client device.

If the client device starts to become overwhelmed with video data, the client device may send a response (e.g. a TCP segment) requesting a smaller reduced TCP window size (e.g. 32 KB). The media gateway may respond by transcoding the video to a lower quality and then transmitting 32 KB of lower quality transcoded video data (e.g. data that has lower quantization resolution) to the client device. This lower quality video makes it easier for the client device to catch up with processing of the video data.

In one example, the adaptive transcoder may increase/decrease the bit rate of the video signal by manipulating the quantization resolution of the data during encoding of the successive images in the video signal. For example, if the video signal is being encoded into an MPEG format at a set resolution, the quantization resolution of high frequency information in the image may be modified to adjust the bit rate of the signal being transmitted to the client device.

During MPEG encoding, the transcoder may operate on 8×8 blocks of data within each image (e.g. 64 pixels of information). First, prior to compression, the transcoder may convert the 8×8 block into the frequency domain using a discrete cosine transform (DCT) or some other equivalent transform. This frequency domain transformation produces an 8×8 block of frequency coefficients that indicate the spatial frequency components of the information within the image. Second, each of the 64 values of the DCT matrix may be operated on by an 8×8 quantization matrix. The coefficients in the quantization matrix are set to quantize the information differently depending on the frequency of the information in the image.

The result of the quantization is a reduction in the amount of information in the image signal. Typically, high frequency information in an image may be quantized more coarsely than low frequency information. This is primarily because quantization deterioration in high frequency information is not as noticeable to the human eye as it is for low frequency information.

The result of the quantization effectively sets the amount of information needed for viewing the video signal, and therefore the bit rate provided to the client. The adaptive transcoder can manipulate the quantization matrix to alter the bit rate depending on the TCP window size requested by the client device.

For example, if the window size is decreased by client device request, then the adaptive transcoder can change the quantization matrix to reduce the quantization resolution or even eliminate high frequency information in the image, thereby lowering the bit rate. Alternatively, if the client device requests an increase in window size, then the adaptive transcoder can change the quantization matrix to include more high frequency information in the image, thereby increasing the bit rate. In either case, the adaptive transcoder can control the bit rate by controlling the quantization resolution during encoding of the video signal. Although quantization resolution is used to control the bit rate, it is noted that other methods may also be used by the adaptive transcoder. For example, the transcoder may adjust the frame rate or the image resolution.

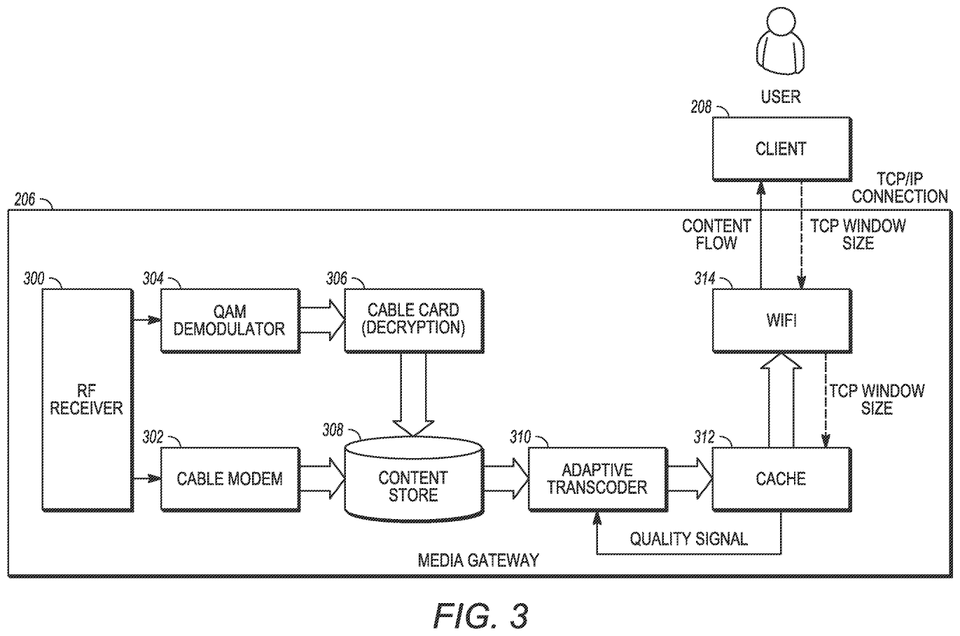

Details of an example of media gateway 206 are shown in FIG. 3. Among others, the media gateway may include an RF receiver 300, a QAM demodulator 304 connected to the RF receiver, a cable modem 302 connected to the RF receiver and receiving data in different frequency bands than the video data and using different communication protocols than the QAM demodulator 304, a cable decryption card 306, a content storage 308, an adaptive transcoder 310, a cache 312 and a WiFi transceiver 314. Each of the devices shown in the media gateway of FIG. 3 may include their own dedicated processors, or may be executed on a common processor. For example, cache 312 may have its own dedicated processor to process the received TCP window size and produce the quality signal (i.e. control signal) sent to adaptive transcoder 310, or cache 312 may share a common processor with adaptive transcoder 310.

In one example, the media gateway 206 may be a hardware box that is installed in the home (e.g. the basement) of the user in order to receive video content from a video service provider (e.g. internet service provider). The client device 208 in this example may be the actual cable box that is controlled via remote control by the user. Alternatively, client device 208 may be a personal computer or some other computer device (e.g. mobile phone) that is receiving video content from media gateway 206.

During operation, software running on at least one processor in the media gateway may cause the media gateway to configure the QAM demodulator to demodulate the signal carrying a desired SPTS. The processor may also cause the media gateway may also configure the cable card to decrypt the encrypted elements of the SPTS. The adaptive transcoder is essentially configured by the processor to accept the decrypted SPTS, and transcode it into a format that is acceptable for client device 208. The transcoder may initially use a set of default decoding parameters for the format and the bit rate acceptable by the client device. The transcoded content may then be encrypted and placed on the cache 312 as a single file to be fetched by client device 208 utilizing, for example, HTTP progressive download which is somewhat similar to streaming video. The digital file in HTTP progressive download as opposed to streaming, however, is downloaded to the client device as a digital file, and is stored in the temporary folder associated with the web browser. Although the example described above utilizes HTTP progressive download, it is noted that other techniques such as video streaming may also be utilized.

In one example, during operation, client device 208 may receive the content from the cache 312 through the TCP/IP connection shown in FIG. 3. Through standard TCP signaling, the client device will pass a TCP segment including a header with the TCP window size information back to the cache 312. This TCP window size indicates the amount of data the client device 208 is willing to receive until an acknowledgment is required. This TCP window size may be set by the client device based on its known processing capabilities, available buffer memory and connection speed/quality between the client device and Wi-Fi transceiver 314.

For example, if the client device consumes data as quickly or more quickly as the video is being delivered, the buffers in the client device will be empty, and the TCP window size in the TCP header will stay the same or increase. This indicates to the media gateway that the client device may be able to handle higher bit rates (i.e. higher quality video). In this example, the cache 312 shown in FIG. 3 may send a message or quality signal (based on the TCP window size) to adaptive transcoder 310 instructing the adaptive transcoder to increase the quality of the video (i.e., increase the bit rate).

If the client device cannot consume data as quickly as the cache 312 is delivering it, the input buffers of that device fill to a threshold level, and then the client device sends a signaling request to reduce the TCP window size. Alternatively, the cache 312 may detect that the transcoder is producing video segments faster than the client device is consuming them, or faster than the network between the media gateway and the client device will allow. In either case, the cache 312 may send a control signal (e.g. quality signal) to adaptive transcoder 310 instructing the adaptive transcoder to decrease the quality of the video and thereby decrease the bit rate of the transcoded stream being sent over TCP/IP to the client device.

Essentially, by monitoring the TCP window size that is indicated by client device 208 during the TCP signaling process, the cache 312 may be able to adjust the bit rate transmitted to the client device. As discussed above, the optimal bit rate for transmission may depend on numerous factors such as the processing capabilities of the client device, available buffer memory in the client device, and the capabilities of the network connection between the media gateway and the client device. This allows the cache 312 either to instruct the adaptive transcoder 310 to increase or decrease the transcoded bit rate depending on the real-time needs of client device 208.

This real-time monitoring and adapting avoids underflow and overflow situations that may occur at client device 208 buffers when the transcoded bit rate is not optimized based on the client device needs. This ensures that the video being is being displayed on the client device to the user at the highest possible quality without producing pauses in the video or other unwanted artifacts that may occur when the bit rates are not optimized (i.e. the client device is receiving data at a suitable data rate).

Although FIGS. 2 and 3 show that the media gateway is monitoring the TCP window size of the client device in order to control the adaptive transcoder's bit rate, it is noted that other signals may be used. In another example, the client device may be configured to monitor its own performance and actively signal its performance requirements and networking conditions to the cache 312 in the media gateway.

It is also noted that the adaptive transcoder will receive a signal from either the cache or the client device. In one example, the signal received by the adaptive transcoder is a control signal (e.g. quality signal) generated by the cache. In another example, the signal received by the adaptive transcoder is an indicator signal (e.g. TCP window size) generated by the client device. In either case, the adaptive transcoder will receive the signal and change the bit rate accordingly.

For example, the client device may determine whether the bit rate needs to be increased or decreased based on how much data is stored in its internal buffers. In one example, if the buffers reach a high-water mark (e.g. a level prior to overflow), then the client device knows that the bit rate needs to be reduced. If the buffers reach a low-water mark (e.g. a level prior to underflow), then the client device knows that the bit rate may be increased. In either case, the client device may actually send an indicator signal indicating its performance and bit rate requirement to the cache 312. This reduces the burden on the cache 312 312, since the cache 312 does not have to determine a quality signal based on the TCP window size. The signal from the client device is utilized to directly control adaptive transcoder 310 into adjusting the bit rate to the bit rate required by the client. It is noted that the indicator signal received by the transcoder may be the TCP window size (e.g. standard bits in header of TCP segment), or a quality signal indicating a quality of the video requested by the client device (e.g. a special signal generated and transmitted by the client device to indicate the exact bit rate that is desired).

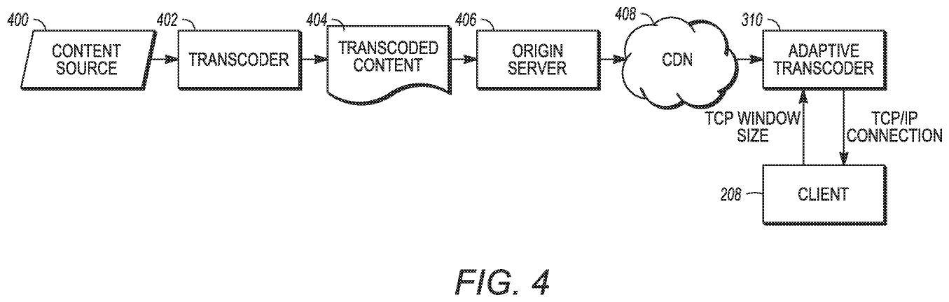

The media gateway shown in FIGS. 2 and 3 is a specific example of cable provider hardware that may be installed in the basement of the user's home or the work place of the user. The various components within media gateway 206 shown in FIG. 3 may not be necessary in certain situations. In one simplified example, as shown in FIG. 4, only the adaptive transcoder 310 is directly connected to the client device 208 over the TCP/IP connection.

In this example, content source 400 may send video to transcoder 402 which produces transcoded content 404. Transcoded content 404 may then be stored on origin server 406 and then transmitted to adaptive transcoder 310 via the content delivery network (CDN) 408. At this point, the adaptive transcoder 310 may transcode the video content to produce and output video having a specified bit rate and transmit the transcoded video content over the standard TCP/IP connection to client device 208.

In this example, the adaptive transcoder 310 does not utilize the cache 312 shown in FIG. 3 but rather directly monitors the TCP signaling being requested by client device 208. It should also be noted that similar to FIG. 3, the client device, itself, may send a quality control signal directly to adaptive transcoder 310 rather than having the adaptive transcoder 310 monitor the TCP window size.

In either case, the adaptive transcoder transcode the video content received over CDN 408 to a specific bit rate. The bit rate initially may be chosen based on past history of the client device and/or an initial request by the client device. During operation, similar to the process described with respect to FIG. 3, the adaptive transcoder increases, decreases or maintains the bit rate depending on the TCP window size being requested by client device 208 or based on a quality signal received from client device 208.

For example, the output of the transcoder 310 may initially be the highest quality possible delivered to the client. An example of the transcoder output may be H.264 high profile resolution of 1920×1080 @ 29.97 frames per second (FPS) at a bit rate of 8 Mbps per second in a MPEG-2 TS container. The transcoder could package the transcoded content files with 10 second duration. It could also produce a manifest file describing how the content files are presented. In another embodiment, the video could be transcoded into a single file. The transcoder may then transcode the content on origin server 406.

During operation, client device 208 may initiate video playback by making an ACTV request for content to the adaptive transcoder 310. The client device may be a web browser running on a PC. A request from client device 208 to adaptive transcoder 310 could be a HTML video tag requesting a particular video file. The request by the client device may include the IP address of the adaptive transcoder along with the name of the video file that is being requested for download.

Upon receiving a request from client device 208, adaptive transcoder 310 may fetch the transcoded content. In parallel with the content fetch, the adaptive transcoder may also select the initial quality and resolution for transmitting the video to client device 208. These initial values may be predefined or based upon previous usage of client device 208. Essentially at this point the adaptive transcoder may deliver the transcoded content to the client.

During operation, the adaptive transcoder may directly monitor TCP window size during the TCP signaling. Alternatively, the adaptive transcoder may directly receive a quality signal from client device 208 indicating a video bit rate requirement of client device 208. In either case, adaptive transcoder 310 attempts to either increase or decrease the bit rate to optimally match the processing capabilities of client device 208 and the network connection between adaptive transcoder 310 and client device 208.

In order for the adaptive transcoder to optimally match the bit rate to the requirements of the client device, the quantization of the successive images in the video signal may be manipulated as described above. For example, the transcoder may manipulate the quantization matrix currently being utilized during the encoding process to either eliminate or increase high frequency content within the images.

In one example, if the TCP window size or the quality signal indicates that the bit rate is too high for the client, then the transcoder may reduce the high frequency content in the images to reduce the bit rate of the video signal from 1920×1080@29.97 FPS at 8 Mbps to 1920×1080@29.97 FPS at 6 Mbps (i.e. an appropriate lower rate). In another example, if the TCP window size or the quality signal indicate that the bit rate is too low, then the transcoder may increase the high frequency content in the images to increase the bit rate of the video signal from 1920×1080@29.97 FPS at 8 Mbps to 1920×1080@29.97 FPS at 10 Mbps (i.e. an appropriate higher rate). In either case, the bit rate is altered based on quantization of the video signal as described above. It should be noted that the resolution and FPS of the video signal in the above described examples were not altered. However, the transcoder could also alter the resolution and/or the FPS in addition to altering the quantization.

It should be noted that the standard TCP signal uses end-to-end flow control to avoid having a device transmit data too fast. In each TCP segment, the receiver may specify, in the received window field, the amount of data that it is willing to buffer for the connection. This informs the transmitter that it may only send that amount of data before waiting for an acknowledgement and a window update from the receiving device (e.g., client device 208).

Thus, client device 208 may increase the requested TCP window size if the bit rate is too low. This lets adaptive transcoder 310 know that it needs to increase the bit rate and transmit better quality data to client device 208. However, if the client device 208 requests a reduction of the window size or advertises a window size of 0, this allows the adaptive transcoder 310 to know that the bit rate being transmitted is too high and that it must be reduced or paused. Alternatively, the client device may directly indicate the desired bit rate that it requires rather than having the adaptive transcoder determine the best bit rate based on the TCP window size.

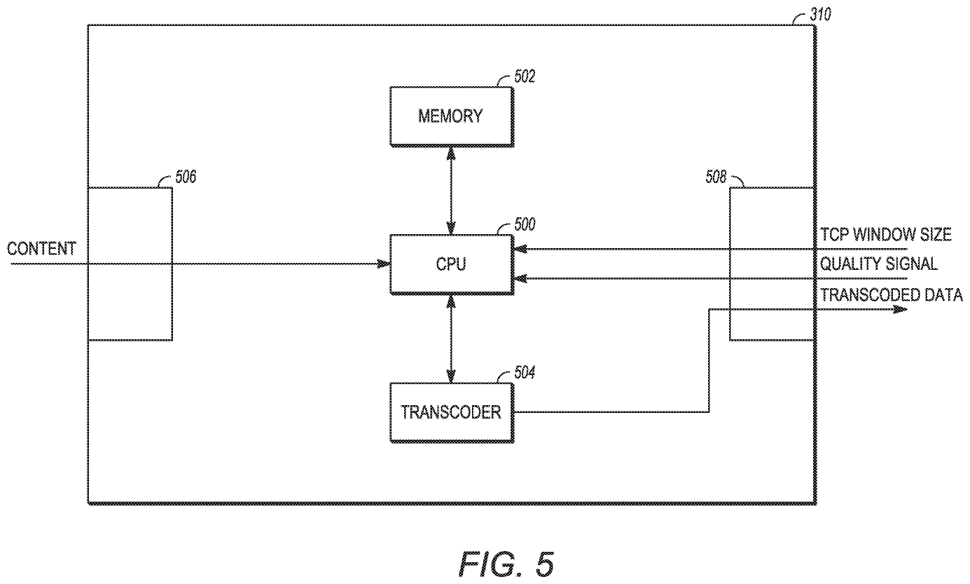

The adaptive transcoders in FIGS. 3 and 4 are shown in detail in FIG. 5. Internally, the adaptive transcoder may include an input port 506, and an output port 508. The adaptive transcoder may also include a central processing unit 500, memory 502 and a transcoding device 504. During operating, CPU 500 may receive the content from the content source. This content may be then passed to transcoder 504 and transmitted over the standard TCP/IP connection as transcoded data to client device 208. However, client device 208 may send the TCP window size and/or a quality signal directly back to CPU 500 of the adaptive transcoder. CPU 500 may then send a control signal to transcoder 504 to either decrease or increase the bit rate of the transcoded data being transmitted to client device 208. The control signal may indicate a desired bit rate computed by the CPU based on a predetermined relationship between the TCP window size and/or the quality signal and a pre-stored table of corresponding bit rates. Alternatively, a formula may be utilized to determine the optimal bit rate (e.g. least mean squares operating on the TCP window size or the quality signal). In either case, once the appropriate bit rate is determined, it is sent to the transcoder, and the transcoder adapts the quantization accordingly. Additional content that is being received from the content source may be stored in memory 502 acting as a cache. The cache may be for the content being received by the content source or may be cached after it is transcoded and before it is transmitted to client device 208.

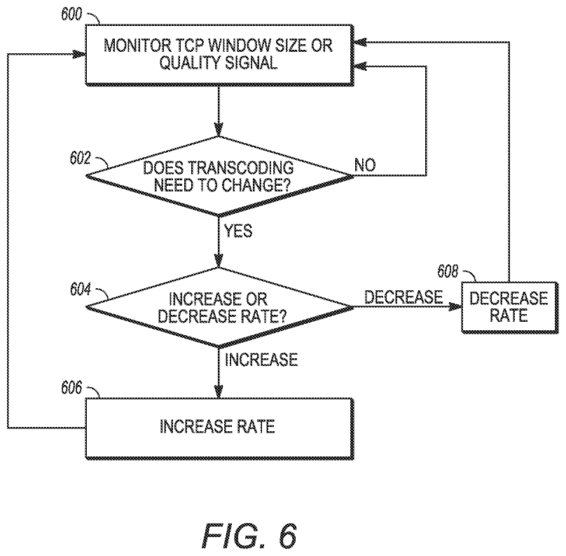

FIG. 6 shows a flow chart of how the adaptive transcoding would operate in a specific example. Specifically, the adaptive transcoder or the cache 312 may monitor the TCP window size or may receive a quality signal directly from client device 208 (see step 600). The adaptive transcoder and/or cache 312 may then determine whether the bit rate needs to changed or not (see step 602). If the bit rate does not need to be changed, then the adaptive transcoder/cache 312 may continue to monitor TCP window size or the quality signal from client device 208 (i.e., the transcoder continues transcoding the data at the same bit rate). However, if it is determined based on the TCP window size or the quality signal that the bit rate does need to be changed, then it is determined whether the bit rate needs to be increased or decreased (see step 604). If it is determined that the bit rate needs to be decreased (e.g., TCP window size has been decreased), then the adaptive transcoder decreases the bit rate (see step 608). However, if it is determined that the bit rate needs to be increased (i.e., the TCP window size has been increased), then the adaptive transcoder may increase the bit rate (see step 606). In either event, the system continues to monitor the TCP window size or the quality signal from client device 208 in order to adapt to the client's needs in real time.

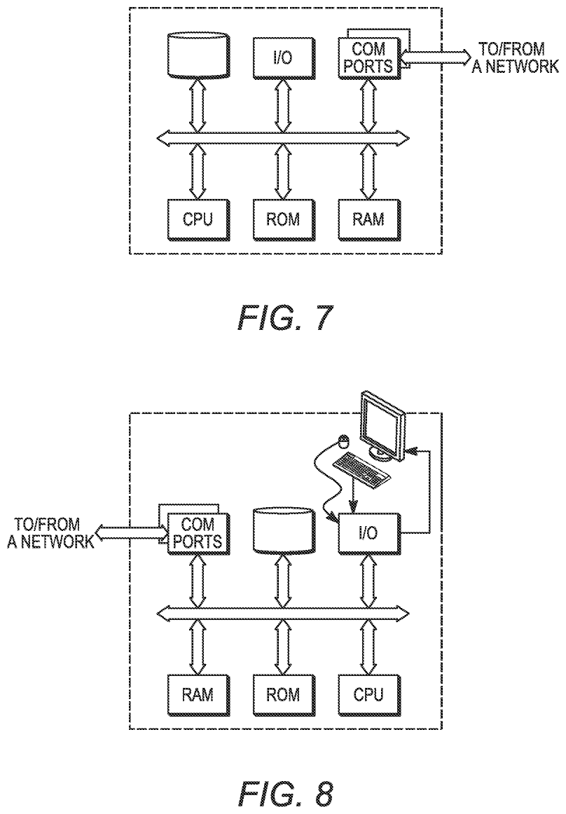

FIGS. 7 and 8 provide functional block diagram illustrations of general purpose computer hardware platforms. FIG. 7 illustrates a network or host computer platform, as may typically be used to implement some of the devices shown in FIGS. 2-4 (e.g. a media gateway with a common processor performing the various functions). FIG. 8 depicts a computer with user interface elements, as may be used to implement a personal computer or other type of work station or terminal device as shown in FIGS. 2-4 (e.g. client device, media gateway, adaptive transcoder), although the computer of FIG. 8 may also act as a server if appropriately programmed. It is believed that the general structure and general operation of such equipment as shown in FIGS. 7 and 8 should be self-explanatory from the high-level illustrations.

In one example, a media gateway implementing the adaptive transcoder, for example, could include a data communication interface for packet data communication. The media gateway could also include a central processing unit (CPU), in the form of one or more processors, for executing program instructions. The media gateway typically includes an internal communication bus, program storage and data storage for various data files to be processed and/or communicated by the server, although the server often receives programming and data via network communications. Of course, the media gateway functions may be implemented in a distributed fashion on a number of similar platforms, to distribute the processing load.

A computer type user terminal device, such as a PC or tablet computer, for implementing the client device 208 or media gateway 206, similarly includes a data communication interface CPU, main memory and one or more mass storage devices for storing user data and the various executable programs (see FIG. 8). A mobile client device type user terminal may include similar elements, but will typically use smaller components that also require less power, to facilitate implementation in a portable form factor. The various types of user terminal devices will also include various user input and output elements. A computer, for example, may include a keyboard and a cursor control/selection device such as a mouse, trackball, joystick or touchpad; and a display for visual outputs. A microphone and speaker enable audio input and output. Some smartphones include similar but smaller input and output elements. Tablets and other types of smartphones utilize touch sensitive display screens, instead of separate keyboard and cursor control elements. The hardware elements, operating systems and programming languages of such user terminal devices also are conventional in nature.

For example, for the media gateway in FIG. 3, the functions of the QAM demodulator, cable modem, cable card, adaptive transcoder and Wi-Fi transceiver may be performed and/or controlled by the CPU in FIGS. 7 and/or 8. Likewise, the functions of the content store and the cache may be performed by the RAM/ROM in FIGS. 7 and/or 8. In either case, the media gateway, the client device (and any other device shown in the figures) may be implemented with the hardware devices shown in FIGS. 7 and/or 8.

Hence, aspects of the methods of providing the adaptive transcoding outlined above may be embodied in programming. Program aspects of the technology may be thought of as “products” or “articles of manufacture” typically in the form of executable code and/or associated data that is carried on or embodied in a type of machine readable medium. For example, programming code for reading the TCP window size, determining an appropriate bit rate for video data based on the TCP window size, and then transcoding data having the appropriate bit rate may be installed in the media gateway (e.g. cable receiver in the basement). “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the service provider into the computer platforms of the media gateway and client device.

Hence, a machine readable medium may take many forms of tangible storage medium. Non-volatile storage media include, for example, optical or magnetic disks, such as any of the storage devices in any computer(s) or the like, such as may be used to implement the client device, media gateway, transcoder, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it may be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1-20. (canceled)

21. A system for transcoding data, comprising: an adaptive transcoder having a processor configured to:
transcode data to produce transcoded data having a first data rate and transmit the transcoded data to a client device using TCP/IP (Transmission Control Protocol/Internet Protocol);
monitor the remaining TCP/IP window size relative to a maximum TCP/IP window size, and indicated by the TCP/IP acknowledgements from the client device during the transmission of the transcoded data;
determine if the remaining TCP/IP window size indicates the first transcoded data rate is deficient; and
transcode the data to produce transcoded data having a second data rate in response to the processor determining that the first data rate is deficient.

22. The system of claim 21, wherein the first data rate is the highest data rate that the adaptive transcoder may transcode data.

23. The system of claim 21, wherein the second rate is greater than the first rate when the processor determines that the client device may process the data at a rate greater than the first rate.

24. The system of claim 21, wherein the transcoder transcodes the data at the second data rate by controlling at least one of video quantization, encoding format and video resolution.

25. The system of claim 21, wherein the data is transcoded and delivered to the client device as a Hypertext Transfer Protocol (HTTP) progressive download.

26. A media gateway, comprising:
a receiver configured to receive data from a content source;
an adaptive transcoder configured to transcode the data and produce transcoded data having a first data rate;
a cache having a processor configured to:
store the transcoded data;
transmit the stored data to a client device using TCP/IP;
monitor the remaining TCP/IP window size relative to a maximum TCP/IP window size, and indicated by the TCP/IP acknowledgements from the client device during the transmission of the stored data;
determine if the remaining TCP/IP window size indicates the first transcoded data rate is deficient; and
send a control signal to the adaptive transcoder instructing the adaptive transcoder to transcode the data and produce transcoded data having second data rate, in response to the processor determining that the first data rate is deficient.

27. The media gateway of claim 26, wherein the first data rate is the highest data rate that the adaptive transcoder may transcode data.

28. The media gateway of claim 26, wherein the second data rate is greater than the first data rate when the processor determines that the client device may process the data at a data rate greater than the first data rate.

29. The media gateway of claim 26, wherein the data is transcoded and delivered to the client device as a HTTP progressive download.

30. A method for transcoding data, comprising:
transcoding data, by a processor, to produce transcoded data having a first data rate;
transmitting, by the processor, the transcoded data to a client device;
monitoring, by the processor, the remaining TCP/IP window size relative to a maximum TCP/IP window size, and indicated by the TCP/IP acknowledgements from the client device during the transmission of the transcoded data;
determining, by the processor, the remaining TCP/IP window size indicates the first transcoded data rate is deficient; and
transcoding, by the processor, the data at a second data rate in response to the processor determining that the first data rate is deficient.

31. The method of claim 30, including: setting, by the processor, the first data rate as the highest data rate of the adaptive transcoder.

32. The method of claim 30, including: setting, by the processor, the second data rate to be greater than the first data rate when the processor determines that the client device may process the data at a rate greater than the first data rate.
